(19) United States
(12) Patent Application Publication
(10) Pub. No.: US 2010/0007070 A1
(43) Pub. Date: Jan. 14, 2010

(54) SHEET PROCESSING APPARATUS, SHEET PROCESSING METHOD AND IMAGE FORMING APPARATUS

(75) Inventors: Ken IGUCHI, Shizuoka (JP); Katsuhiko Tsuchiya, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHKI KAISHA, Tokyo (JP)

(21) Appl. No.: 12/495,624

(22) Filed: Jun. 30, 2009

Related U.S. Application Data
(60) Provisional application No. 61/079,713, filed on Jul. 10, 2008.
(60) Provisional application No. 61/083,451, filed on Jul. 24, 2008.

(30) Foreign Application Priority Data
Dec. 24, 2008 (JP) 2008-327657

(51) Int. Cl. B65H 7/00; B65H 5/00; B65H 9/00; B42B 2/00; B41F 13/00; B65H 39/00

(52) U.S. Cl. 270/18; 271/3.06; 271/228; 270/52.18; 270/58.11

(57) ABSTRACT

According to one embodiment, a sheet processing apparatus includes a first supporting member which supports a sheet and drops the sheet, a second supporting member which supports the sheet dropped from the first supporting member, a stacking member which stacks sheets, a first discharge member which discharges sheet from the first supporting member to the stacking member, a second discharge member which discharges the sheet on the second supporting member to the stacking member and a control unit. The control unit controls the first discharge member to discharge the sheet one by one from the first supporting member to the stacking member or to drop the sheet to the second supporting member on the basis of a threshold value or a predetermined value different from the threshold value.

### CROSS-REFERENCE TO RELATED APPLICATION

This application is based upon and claims the benefit of priority from the prior U.S. provisional Patent Application No. 61/079,713, filed on Jul. 10, 2008; the entire contents of all of which are incorporated herein by reference.

This application is also based upon and claims the benefit of priority from the prior U.S. provisional Patent Application No. 61/083,451, filed on Jul. 24, 2008; the entire contents of all of which are incorporated herein by reference.

This application is based upon and claims the benefit of priority from the prior Japanese Patent Application No. 2008-327657, filed on Dec. 24, 2008, the entire contents of all of which are incorporated herein by reference.

### FIELD OF THE INVENTION

Exemplary embodiments described herein relate to a sheet processing apparatus for discharging a sheet conveyed, a sheet processing method and an image forming apparatus.

### DESCRIPTION OF THE BACKGROUND

Japanese Patent Publication No. 2007-22691 discloses an apparatus for discharging a sheet. The apparatus includes a tray for stacking discharged sheet, a detector for detecting an amount of sheets stacked on the tray, a first exit for discharging a sheet to the tray and a second exit for discharging a sheet to the tray from a location higher than the first exit. As an amount of sheets stacked on the tray are increased, the apparatus changes from the first exit to the second exit. The apparatus can load sheets from the second exit on top of sheets stacked on the tray discharged from the first exit when amount of the sheets on the tray from the first exit becomes its upper limit.

Further, a sheet conveying path toward the second exit is longer than that toward the first exit for cooling a sheet while conveying the sheet along the sheet conveying path. So toner which is not firmly fixed on the sheet yet is prevented from sticking sheets stacked on the tray one to the other.

However, in the apparatus aforementioned, since the sheet conveying path is narrow, the sheet conveying path tends to be filled with heat. If a sheet is discharged before it is cooled sufficiently, it is difficult to prevent the discharged sheet from adhering to other sheet on the tray with such toner being insufficiently cooled. Further, for example, if a lot of sheets with a high temperature are stacked on the tray, toner images on the respective sheets are pressed by the weight of stacked sheets and thus will be easy to stick to the sheet stacked.

### SUMMARY OF THE INVENTION

A sheet processing apparatus provided in an embodiment of the present invention comprises a first supporting member configured to support a sheet in a first state and drop the sheet in a second state, a second supporting member configured to support the sheet dropped from the first supporting member, a stacking member configured to stack sheets, a first discharge member configured to discharge sheets one by one from the first supporting member to the stacking member, a second discharge member configured to discharge a sheet on the second supporting member to the stacking member and a control unit configured to instruct the first discharge member to discharge a sheet from the first supporting member to the stacking member if a volume of sheets discharged to the stacking member is a first value smaller than a threshold value and to instruct the first supporting member to drop the sheet thereon to the second supporting member if the volume of sheets discharged to the stacking member is a second value greater than the threshold value.

Furthermore, a sheet processing method for discharging a sheet to a stacking member provided in an embodiment of the present invention comprises, supporting a conveyed sheet by a first supporting member, discharging the sheet from the first supporting member to the stacking member if a volume of sheets discharged to the stacking member is a first value smaller than a threshold value, dropping the sheet supported on the first supporting member to a second supporting member if the volume of sheets discharged to the stacking member is a second value greater than the threshold value, and discharging the sheet on the second supporting member to the stacking member.

### BRIEF DESCRIPTION OF THE DRAWINGS

FIG. 1 is a schematic diagram of the image forming apparatus;

FIG. 2 is a schematic diagram of the sheet post-processing apparatus;

FIG. 3 is a schematic perspective view around the waiting tray;

FIG. 4 is a schematic diagram for explaining the each drive of the waiting tray and the waiting roller;

FIG. 5 is a schematic perspective view around the processing tray;

FIG. 6 is a schematic block diagram of the control system for the image forming apparatus and sheet post-processing apparatus;

FIG. 7 is a flow chart for explaining an example of the operation of the main controller determining sheet ejection end;

FIG. 8 is a flow chart for explaining an example of the operation of the controller determining sheet ejection end;

FIG. 9 is a flow chart for explaining the sheet buffering operation of the waiting tray;

FIG. 10A to 10L are diagram for explaining a state in which three sheets are placed on a waiting tray;

FIG. 11 is a flow chart for explaining an example of discharge control of the sheet post-processing apparatus;

FIG. 12 is a flow chart for explaining a further example of discharge control of the sheet post-processing apparatus;

FIG. 13 is a flow chart for explaining a further example of discharge control of the sheet post-processing apparatus;

FIG. 14 is a flow chart for explaining a further example of discharge control of the sheet post-processing apparatus;

FIG. 15 is a flow chart for explaining a further example of discharge control of the sheet post-processing apparatus;

FIG. 16 is a flow chart for explaining a further example of discharge control of the sheet post-processing apparatus;

FIG. 17 is a flow chart for explaining a further example of discharge control of the sheet post-processing apparatus;

FIG. 18 is a flow chart for explaining a further example of discharge control of the sheet post-processing apparatus;

FIG. 19 is a flow chart for explaining a further example of discharge control of the sheet post-processing apparatus; and

FIG. 20 is a flow chart for explaining a further example of discharge control of the sheet post-processing apparatus.

### DETAILED DESCRIPTION OF THE INVENTION

Hereinafter, embodiments of the present invention will be explained with reference to accompanying drawings.

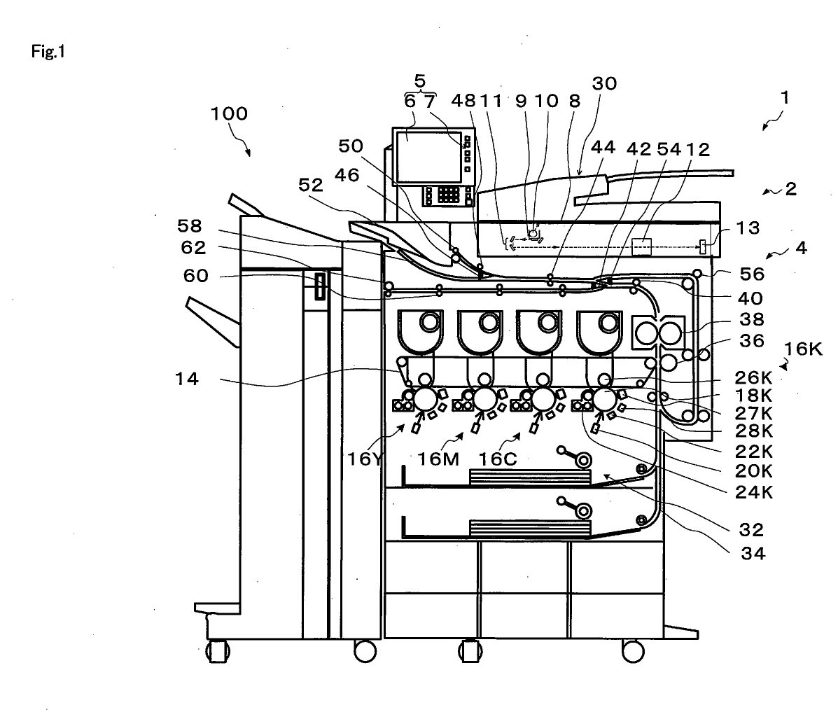

FIG. 1 is a schematic diagram of an image forming apparatus.

An image forming apparatus 1 includes a scanner 2 for reading an image of document and a printer 4 for forming the image. The image forming apparatus 1 has an operation panel 5 which includes a display 6 of a touch panel type and various operation keys 7.

The operation keys 7 of the operation panel 5 include, for example, a ten-key, a reset key, a stop key, and a start key. The display 6 receives inputs of various instructions or values, for example, sheet size, number of copies, print density, stapling and folding.

The scanner 2 includes a platen plate 8, a carriage 9, an illuminating lamp 10, a reflecting mirror 11, a lens 12, and a CCD 13 (Charge Coupled Device). The lens 12 converges a light reflected by the mirror 11. The CCD 13 is a photoelectric conversion device for receiving the reflected light and converting the received light to an electric signal. Above the platen 8, an automatic document feeder 30 for conveying a document to a reading position is installed.

The printer 4, e.g., color printer includes an intermediate transferring belt 14 as a transfer medium and four processing units 16Y, 16M, 16C, and 16K, corresponding to colors of yellow (Y), magenta (M), cyan (C), and black (K) respectively, which are arranged side by side along the intermediate transferring belt 14.

The processing unit 16K includes a photoconductor 18K acting as an image carrier, a laser unit 20K for forming an electrostatic latent image on the photoconductor 18K, a charger 22K, a developing device 24K, a primary transferring device 26K located in the opposite side of the photoconductive 18K across the intermediate transferring belt 14, a cleaner 27K, and a charge elimination lamp 28K. The processing unit 16Y, 16M, and 16C, have a similar constitution to that of the processing unit 16K aforementioned. Hereinafter, an operation of image forming will be explained with reference to the processing unit 16K.

Firstly, a document is put on the reading position of the platen plate 8 or conveyed to the reading position by the automatic document feeder 30. Then the lamp 10 supported by the carriage 9 emits light to the document from the underneath of the platen plate 8. The mirror 11 induces the reflected light from the document to the lens 12. The reflected light representing image information from the document is projected to the CCD 13 by the lens 12. The CCD 13 receives the reflected light and outputs the image information of the document as an analog signal. The electronic signal transmitted from CCD 13 is converted to a digital signal. The laser unit 20K receives the digital signal whose image is image-processed prior to the reception.

When the image formation is started by the printer 4, the charger 22K charges the outer peripheral surface of the photoconductor 18K which rotates. According to the image-processed digital signal, the laser unit 20K irradiates a laser beam onto the outer peripheral surface of the photoconductor 18K being charged at a uniform potential in the axial direction by the charger 22K and thus forms an electrostatic latent image. The developing device 24K provides a black developer (for example, toner) to the outer peripheral surface of the photoconductor 18K and develops with toner the electrostatic latent image to a toner (K) image. The primary transferring device 26K transfers electrostatically the toner (K) image to the intermediate transferring belt 14.

The cleaner 27K which is positioned at the downstream side of the primary transferring device 26K in the rotational direction of the photoconductor 18K removes the toner remaining on the photoconductor 18K without being transferred. The charge elimination lamp 28K located at the downstream side of the cleaner 27 in the rotational direction of the photoconductor 18K removes the residual electric charge on the outer peripheral surface of the photoconductor 18K. In the case that a color image is formed, the aforementioned operation is repeatedly performed by the processing units 16Y, 16M, and 16C, respectively.

A secondary transferring device 36 transfers electrostatically the toner image, which is being transferred onto the intermediate transferring belt 14, to a sheet conveyed by a sheet feeder 32 via a conveying path 34. A fixing device 38 fixes the toner image on the sheet. A conveying roller 40 conveys the sheet on which the toner image is fixed, to a branching member 42.

The branching member 42 guides the sheet to a reversing roller 44 or to a conveying roller 60 on the basis of respective processes of the sheet. If the branching member 42 guides the sheet to the reversing roller 44, the reversing roller 44, a branching member 46 and conveying roller 48 convey the sheet to a discharge roller 50. Then, the discharge roller 50 discharges the sheet onto an upper catch tray 52.

In the case of duplex printing, the branching member 42 guides the sheet to the reversing roller 44. The reversing roller 44 rotates in a reverse direction and conveys the sheet to a branching member 54. The branching member 54 guides the sheet to a conveying roller 56 and the conveying roller 56 conveys the sheet to the secondary transferring device 36. The secondary transferring device 36 transfers the toner image onto the rear surface of the sheet opposite to the surface on which the image is being fixed. The fixing device 38 fixes the toner image on the sheet. If the sheet size is large (for example, A3 size), the branching member 46 guides the A3 size sheet to a reversing paper path 58 and the reversing roller 44 rotates in a reverse direction and conveys the A3 size sheet to the branching member 54.

When the branching member 42 guides the sheet to the conveying roller 60, the conveying roller 60 conveys the sheet to a conveying roller 62. The conveying roller 62 discharges the sheet to a post-sheet processing apparatus 100. It should be noted that sheet referred hereto may be, for example, an ordinary paper, a thick paper, a thin paper, a glossy paper, or an OHP sheet, etc.

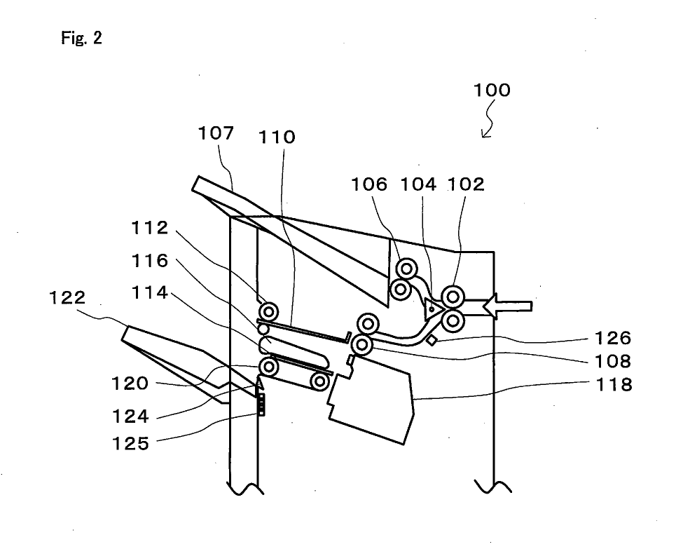

FIG. 2 is a schematic diagram of the post-sheet processing apparatus.

The post-sheet processing apparatus 100 has an entrance roller 102, a branching member 104, a discharge roller 106, an exit roller 108, a standby tray (first supporting member) 110, a standby roller (first discharge member) 112, a processing tray (second supporting member) 114, an alignment member 116, a stapler 118, a discharge member (second discharge member) 120, a fixed tray 107 and a movable tray (stacking member) 122.

The entrance roller 102 receives the sheet from the image forming apparatus 1 by which the image is formed on the sheet and conveys the sheet to the branching member 104. The branching member 104 guides the sheet to either the discharge roller 106 or the exit roller 108.

If the branching member 104 guides the sheet to the discharge roller 106, the discharge roller 106 discharges the sheet onto the fixed tray 107. Meanwhile, if the branching member 104 guides the sheet to the exit roller 108, the exit roller 108 conveys the sheet to the standby tray 110.

The standby tray 110 acts as a buffer. The standby tray 110 holds temporarily a plurality of sheets conveyed. After supporting a predetermined number of sheets, the standby tray 110 drops the supported sheets on the processing tray 114.

The processing tray 114 receives the sheets the standby tray 110 drops. While the sheets are aligned and stapled, the processing tray 114 supports the stacked sheets. The alignment member 116 aligns the end side of sheets stacked on the processing tray 114 in a width direction crossing a sheet conveying direction. The stapler 118 staples the end side of the aligned sheets. The discharge member 120 discharges the stapled sheets to the movable tray 122. On the other hand, the stacked sheets on the processing tray 114 may be aligned and discharged to the movable tray 122 without being stapled by the stapler 118.

The movable tray 122 moves up and down. A detector 124 detects an upper surface of the movable tray 122 or the upper-most surface of the sheets stacked on the movable tray 122. A detector group 125 detects the position of the movable tray 122. The movable tray 122 moves up and down in response to paper ejection from the standby tray 110 or the processing tray 114 or amount of sheets stacked on the movable tray 122. The movable tray 122 receives the discharging sheet at a position where the detector 124 detects either the upper surface of the movable tray 122 or the upper-most surface of the sheets stacked on the movable tray 122.

For example, if the one sheet or a plurality of sheets are discharged, the movable tray 122 moves downward. When the detector 124 becomes that it can not detect the upper surface of the sheet loaded on the movable tray 122, the movable tray 122 moves upward. The movable tray 122 moves to a position where the detector 124 detects the upper-most surface of the sheets stacked on the movable tray 122. And there, the movable tray 122 receives a discharged sheet. A detector 126 then detects the sheet conveyed.

The standby tray 110 may convey a sheet supported thereon towards the movable tray 122 directly and discharge the sheet without dropping the sheet to the processing tray 114. In this case, the standby tray 110 and the standby roller 112 discharge sheets one by one to the movable tray 122 without stopping the sheet on the standby tray 110.

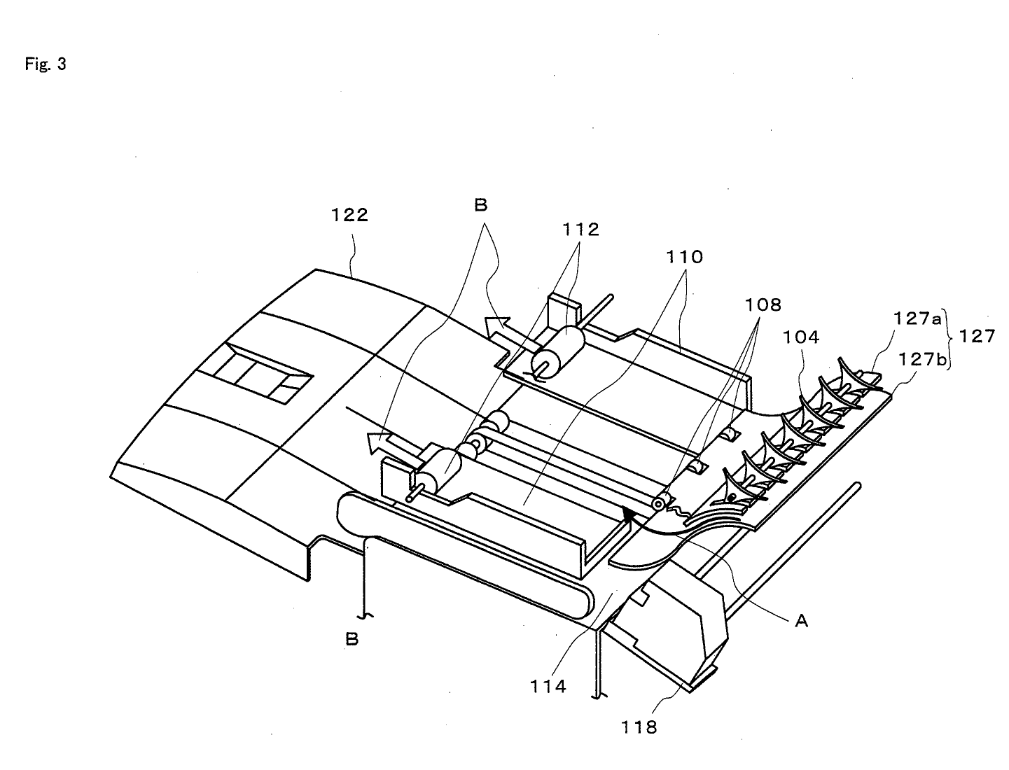

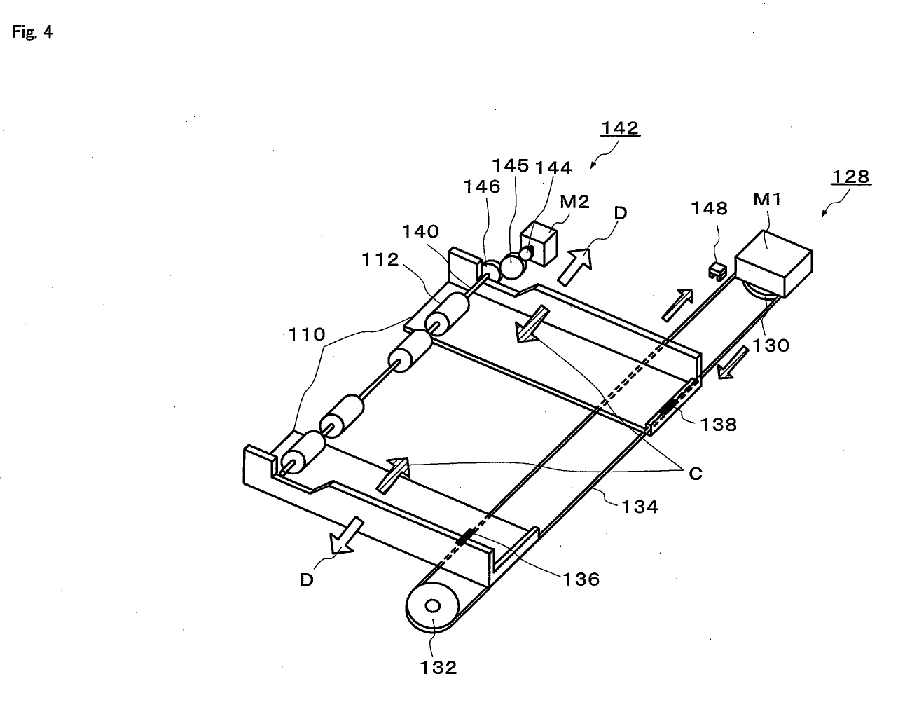

FIG. 3 is a schematic perspective view around the standby tray. FIG. 4 is a schematic diagram for explaining respective drive mechanisms of the standby tray and the standby roller.

The branching member 104 guides a sheet to the exit roller 108. The sheet is conveyed along a guide 127 from the branching member 104 to the exit roller 108. The guide 127 includes guides 127a and 127b. The sheet moves between the guides 127a and 127b, as shown in an arrow A in FIG. 3. The exit roller 108 conveys the sheet conveyed from the branching member 104 to the standby tray 110.

The standby tray 110 is composed of a pair of supporting members. The standby tray 110 is disposed to be inclined so that the downstream side hereof is higher than the upstream side in the sheet conveying direction with regard to the horizontal plane. The standby tray 110 supports the sheet with the both side thereof in a sheet width direction crossing the sheet conveying direction (hereinafter referred to as a width direction of sheet). The standby roller 112 is disposed in the downstream side of the standby tray 110. The processing tray 114 and the alignment member 116 are positioned under the standby tray 110.

The standby tray 110 moves in opposite directions respectively along the width direction of sheet by a drive mechanism 128, as shown in an arrow C or an arrow D in FIG. 4. The drive mechanism 128 includes a motor M1, a pair of pulleys 130 and 132, and a belt 134. The motor M1 may be, for example, a stepping motor. The belt 134 is suspended over the pulleys 130 and 132. The pair of supporting members of the standby tray 110 is attached on the belt 134 with attaching members 136 and 138 respectively. If one of the pair of supporting members is attached on one side of the belt 134 which faces each other across the pulleys 130 and 132, the other supporting member is attached on the other side of the belt 134 across the pulleys 130 and 132. The motor M1 drives the belt 134 via the pulley 130. The belt 134 moves the standby tray 110.

The standby roller 112 is attached on a shaft 140 which extends in the width direction of sheet. The standby roller 112 is rotatably supported by a lift unit (not shown) via the shaft 140. The lift unit lifts up and down the standby roller 112. Thus, the standby roller 112 disconnects from the standby tray 110 or contacts the standby tray 110. The standby roller 112 rotates by a drive mechanism 142. The drive mechanism 142 includes a motor M2, and gears 144, 145 and 146. The gear 146 is attached on the end of the shaft 140. When a driving power of the motor M2 is transmitted to the shaft 140 of the standby roller 112 via gears 144, 145, and 146, the standby roller 112 rotates.

A detector 148 detects a position of the standby tray 110 in the width direction of sheet. The detector 148 may be, for example, a micro-sensor or a micro-actuator. In this embodiment, the detector 148 detects that the standby tray 110 is in the fully opened state (Home Position, HP) in the width direction of sheet. The position of the standby tray 110 is controlled by number of pulses supplied to the motor M1 with regard to the HP. The standby tray 110 moves between a closed state (a first state or a first shape) and an opened state (a second state or a second shape). The closed state is a state in which a distance between ends of the supporting members contacting surface of the sheet is a first distance (first spacing) narrower than the width of the sheet. The opened state is a state in which the distance between ends of the supporting members contacting surface of the sheet is a second distance (second spacing) wider than the width of the sheet. The standby tray 110 supports or guides the sheet in the closed state (first distance). The standby tray 110 drops the sheet onto the processing tray 114 in the opened state (second distance). The first distance and the second distance may be set based on the sheet size.

While the standby tray 110 can drop the sheet onto the processing tray 114 as aforementioned, the standby tray 110 can discharge the sheet to the movable tray 122 using the standby roller 112, as shown in an allow B in FIG. 3, without dropping the sheet onto the processing tray 114.

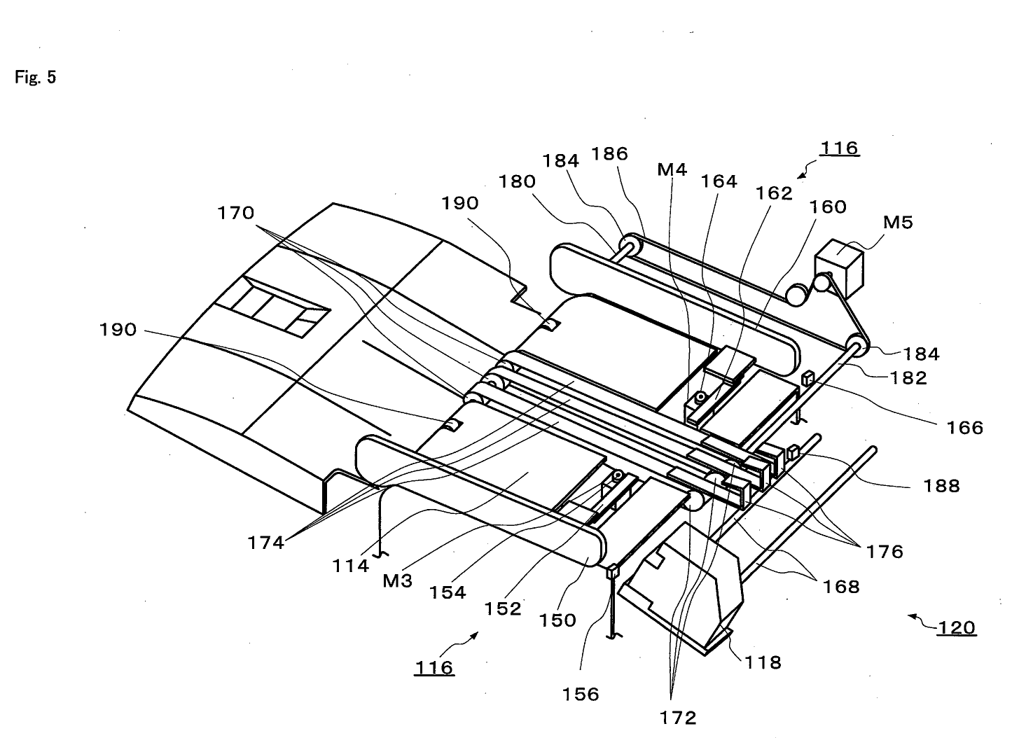

A construction around the processing tray 114 will be explained referring to FIG. 5. The processing tray 114 is disposed under the standby tray 110. The processing tray 114 includes a supporting surface which supports a sheet. The alignment member 116, the stapler 118, and the discharging member 120 are disposed near the processing tray 114.

The alignment member 116 aligns the sheet on the processing tray 114 in the width direction of sheet crossing the sheet conveying direction. The alignment member 116 includes a pair of alignment plates 150 and 160, bridging member 152, 162, and motor M3, M4. The bridging member 152, 162 is attached on the alignment plate 150, 160. The motor M3, M4 makes the alignment plate 150, 160 slide in opposite direction one the other along the width direction of sheet. The alignment plate 150, 160 includes an alignment surface which contacts the end of the sheet in the width direction thereof on the processing tray 114. The alignment surface of the alignment plate 150, 160 is disposed at almost vertical on the supporting surface of the processing tray 114. The bridging member 152, 162 includes a rack which meshes a gear. The motor M3 includes a gear 154 and the M4 includes a gear 164 respectively. The gear 154 meshes the rack of the bridging member 152 and the gear 164 meshes the rack of the bridging member 162. When the motor M3, M4 drives, the alignment plate 150, 160 slides in opposite direction respectively along the width direction of sheet. The motor M3, M4 may be, for example, stepping motor.

A detector 156, 166 detects the position of the alignment plate 150, 160 in the width direction of sheet. The detector 156, 166 may be, for example, a micro-sensor or a micro-actuator, etc. In this embodiment, the detector 156, 166 detects that the alignment member 116 is in the state (Home Position, herein referred to as HP) fully opened in the width direction of sheet. The position of the alignment member 116 is controlled by number of pulses supplied to the motor M3, M4 with regard to the HP. The alignment member 116 moves between an opened state (a third state or a third shape) and a closed state (a fourth state or a fourth shape). The opened state is a state in which a distance between the alignment plates 150 and 160 is a third distance (third spacing) wider than the width of the sheet. The closed state is a state in which the distance between the alignment plates 150 and 160 is a fourth distance (fourth spacing) narrower than the third distance. The alignment member 116 aligns sheet in the closed state of the fourth distance. The third distance and the fourth distance may be set based on the sheet size.

The stapler 118 staples the end of the sheets aligned by the alignment member 116. The stapler 118 moves along a shaft 168 and staples the sheets at a predetermined stapling position. On the basis of the instruction by a main controller 200, a controller 210 controls the stapling position. User can set a desired stapling position via the operation panel 5 or a PC (Personal Computer).

The discharge member 120 discharges sheets on the processing tray 114 to the movable tray 122. The discharge member 120 includes a roller 170, 172, a belt 174, and a guide 176. The belt 174 is suspended over the rollers 170 and 172. The guide 176 is attached on the belt 174. The roller 170 rotates via a shaft 180. The roller 172 rotates via a shaft 182. Pulleys are attached on the end of the shafts 180 and 182. A driving power of a motor M5 is transmitted to a pulley 184 via a belt 186. The guide 176 moves toward the movable tray 122 and pushes out the sheets on the processing tray 114 to the movable tray 120. A detector 188 detects a position of the guide 176. The detector 188 may be, for example, a micro-sensor or a micro-actuator. A conveying roller 190 is attached on the shaft 180. The conveying roller 190 assists movement of sheets. The conveying roller 190 attached on the shaft 180 may be interlocked with the roller 170 to rotate.

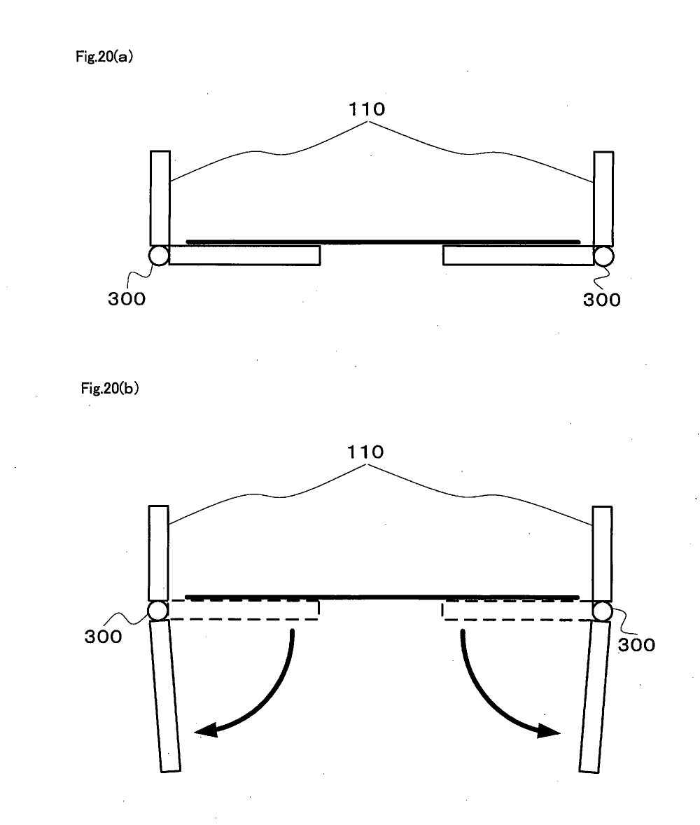

The standby tray 110 may have, for example, a construction as shown in FIG. 20. As shown in FIG. 20(a), the standby tray 110 supports sheet in the first state in which the distance between the ends of the supporting members contacting the sheet is narrower than the width of the sheet. And as shown in FIG. 20(b), the supporting members of the standby tray 110 turn around an attachment 300. The standby tray 110 drops the sheet in the second state in which the distance between the ends of the supporting members is wider than the first distance.

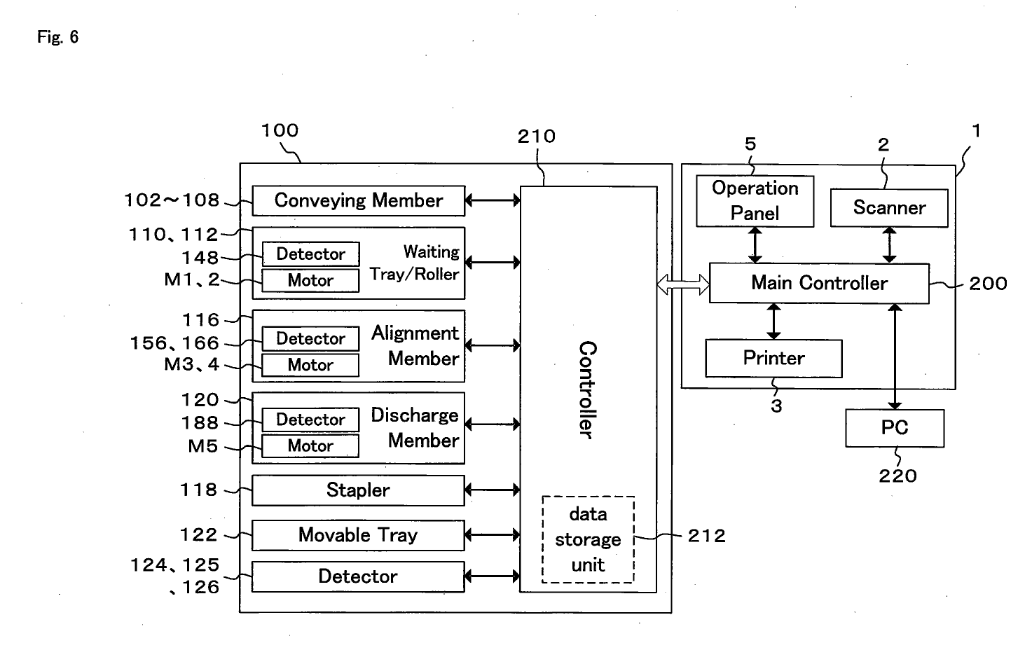

FIG. 6 is a schematic block diagram of the control system for the image forming apparatus and post-sheet processing apparatus. The image forming apparatus 1 has the main controller 200. The main controller 200 controls the scanner 2, the printer 4, the operation panel 5, and the controller 210 of the post-sheet processing apparatus 100. The main controller 200 corrects, compresses, or expands image data. The main controller 200 furthermore stores the compressed image data and print data, etc. The main controller 200 also communicates with a PC 220 outside the image forming apparatus 1.

The controller 210 of the post-sheet processing apparatus 100 has a data storage unit 212. The data storage unit 212 is a ROM (Read Only Memory) which stores a control program etc., a RAM (Random Access Memory) providing a work-area for operating or a HDD (Hard Disk Drive), etc. The controller 210 controls operations of the entrance roller 102, the branching member 104, the discharge roller 106, the exit roller 108, the standby tray 110, the standby roller 112, the alignment member 116, the stapler 118, the discharge member 120, the movable tray 122, and the motors M1˜M5. The controller 210 also controls detectors for each element.

(A sheet ejection end: Destination) The main controller 200 and/or controller 210 may decide to discharge a sheet to one of the sheet ejection ends, i.e., upper catch tray 52, fixed tray 107 and movable tray 122, based on the processing parameters, such as, e.g., number of copy sets, copy/print function, sorting and stapling.

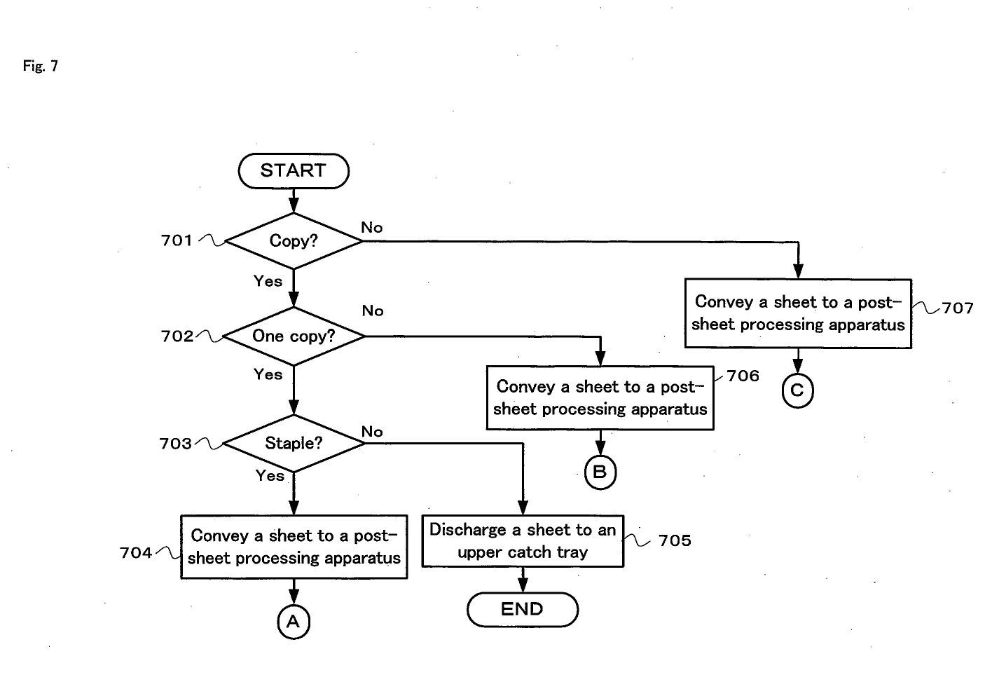

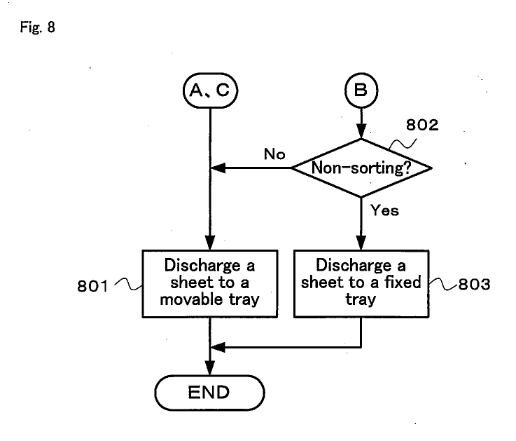

FIG. 7 is a flow chart for explaining an example of the operation of the main controller 200 determining a sheet ejection end. FIG. 8 is a flow chart for explaining an example of the operation of the controller 210 determining a sheet ejection end.

After receiving a job for image-forming instructed from the operation panel 5 or PC 220, the main controller 200 judges whether the job is a copying or a printing at 701. If the job is a copying (Yes at 701), the main controller 200 judges whether the copying is one set or not at 702. If the copying is one set (Yes at 702), the main controller 200 judges whether the job is set to a stapling for stapling sheets by the stapler 118 or not at 703. If the job is set to the stapling (Yes at 703), the main controller 200 provides instructions to convey the sheet to the post-sheet processing apparatus 100 (hereinafter referred to as process A) at 704.

If the job is a copying of one set and the stapling isn't set (No at 703), the main controller 200 determines the upper catch tray 52 of the image forming apparatus 1 as a sheet ejection end at 705.

If the job is copying of a plural sets (No at 702), the main controller 200 gives instructions to convey sheet to the post-sheet processing apparatus 100 (hereinafter referred to as process B) at 706. Meanwhile, if the job isn't copying (No at 701), the main controller 200 gives instructions to convey sheet to the post-sheet processing apparatus 100 (hereinafter referred to as process C) at 707.

When sheet is conveyed to the post-sheet processing apparatus 100, the controller 210 judges the sheet ejection end where the sheet is discharged, either one of the fixed tray 107 and the movable tray 122. If sheet is conveyed to the post-sheet processing apparatus 100 on the basis of the judgment at 704 or 707, the controller 210 determines the movable tray 122 as a sheet ejection end (at 801). Meanwhile, if the sheet is conveyed to the post-sheet processing apparatus 100 based on the judgment at 706, the controller 210 judges whether the job is a non-sorting or not at 802. If the job is the non-sorting (Yes at 802), the controller 210 determines the fixed tray 107 as a sheet ejection end at 803. Meanwhile, if the job isn't the non-sorting (No at 802), the controller 210 selects the movable tray 122 as a sheet ejection end.

In the aforementioned operation, the main controller 200 and controller 210 decide the sheet ejection end on the basis of the processing parameters, i.e., number of copy sets, copy/print functions, sorting, stapling and the like. However, the processing parameters are not limited to the aforementioned settings, it may further include, for example, one-side/both-side printing or a number of pages, and the like. The sheet ejection end which is determined based on the combination of the aforementioned parameters is one example. The sheet ejection end may be set or changed by a maker or user.

Moreover, in the aforementioned operation, first the main controller 200 judges the sheet ejection end, and if the sheet is conveyed to the post-sheet processing apparatus 100, the controller 210 takes over the operation for judging the sheet ejection end from the main controller 200. However, for example, the main controller 200 may judge the sheet ejection end including the tray of the post-sheet processing apparatus 100. Alternatively, a user may select the sheet ejection end via the operation panel 5.

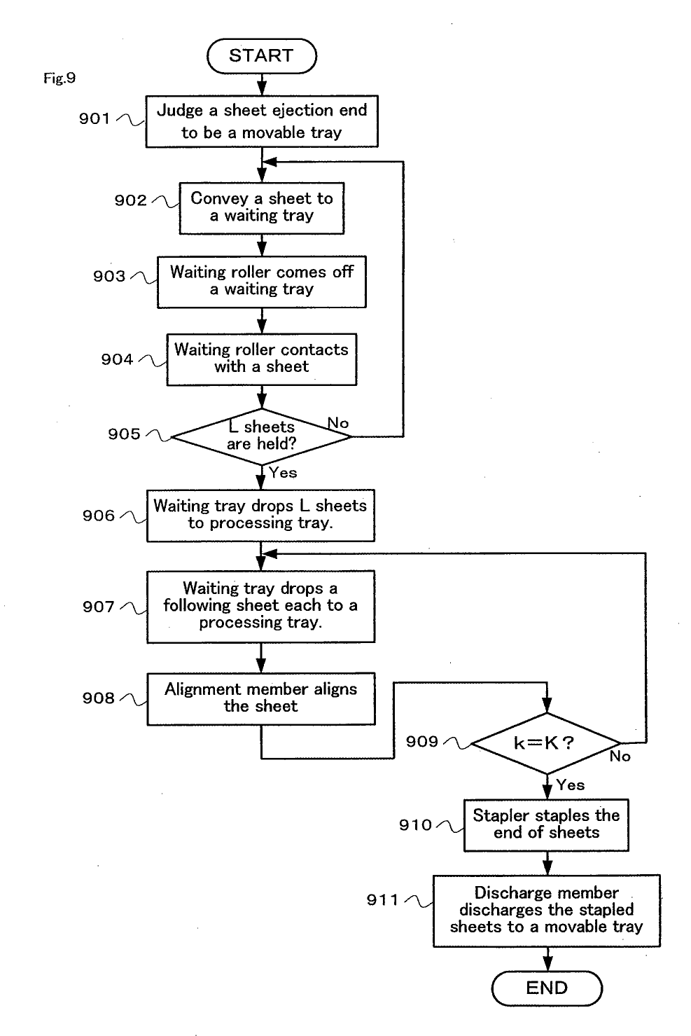

(Sheet discharging to the movable tray: sheet buffering operation of the standby tray) The processing for discharging a sheet to the movable tray 122 of the post-sheet processing apparatus 100 will be explained. Processes when sheet is discharged to the movable tray 122 may be, for example, stapling which staples sheets by the stapler 118, sorting which sorts sheets and the like. While sheets on the processing tray 114 are aligned, stapled or discharged, the standby tray 110 buffers sheets conveyed from the image forming apparatus one after another. Therefore, the time sheet is processed can be secured and a total performance (through-put) of the image forming and the post-sheet processing can be improved. FIG. 9 is a flow chart for explaining the sheet buffering operation of the standby tray. Hereinafter, as an example, the operation when the stapling was instructed is explained. The flow chart indicates K as a total number of sheets, L (K>L) as a number of sheets which is buffered onto the standby tray 110 and k as a number of sheets conveyed to the standby tray 110 within the total number of sheets K. Number of sheets L or k, for example, can be obtained such that the controller 210 counts sheets detected by the detector 126.

If the stapling is instructed, the controller 210 judges the movable tray 122 as a sheet ejection end (at 901). After the entrance roller 102 conveys the first sheet from the image forming apparatus 1 into the post-sheet processing apparatus 100, the branching member 104 and the exit roller 108 convey the sheet to the standby tray 110 at 902.

If a front end of the sheet is conveyed to near the standby roller 112, the standby roller 112 comes off the standby tray 110 (at 903). If the first sheet is further conveyed by the exit roller 108, the standby roller 112 comes close to the standby tray 11, contacts the sheet on the standby tray 110, and presses down the sheet to the standby tray 110 (at 904). By pressing down the sheet as mentioned above, the standby tray 110 is capable of holding the sheet steadily. The controller 210 repeats the operations of steps 902 to 904 until number of sheets stacked on the standby tray 110 becomes L (at 905). The value L is a predetermined number of sheets.

When number of sheets stacked on the standby tray 110 becomes L at 905, the controller 210 directs the standby tray 110 to drop number of sheets L to the processing tray 114 (at 906). After number of sheets L are dropped onto the processing tray 114, the controller 210 controls the standby tray 110 to hold a successive sheet temporarily and to drop the sheet to the processing tray 114 one by one (at 907). At 908, the alignment member 116 aligns sheets in the width direction of sheet.

The controller 210 counts the number of sheets k conveyed to the standby tray 110 within the total number of sheets L (one sheet bundle to be stapled). At 909, the controller 210 judges whether the value k is equal to a value K or not, in other word, whether the sheet conveyed to the standby tray 110 is a last page or not. If the value k isn't equal to the value K, the process goes back to 907, the controller 210 controls the standby tray 110 to hold the following sheet temporarily and to drop the following sheet on the processing tray 114 one by one. If the value k is equal to the value K, the stapler 118 staples the end of the sheets (one sheet bundle) at 910. After stapling the sheets, the discharge member 120 discharges the stapled sheets to the movable tray 122 (at 911).

At 907, the sheet is dropped on the processing tray 114 one by one. However, as similar to 905, sheets stacked on the standby tray 110 may be dropped on the processing tray 114 when number of sheets on the standby tray 110 becomes L′. The value L′ is also a predetermined value different from the value L (e.g., L′<L).

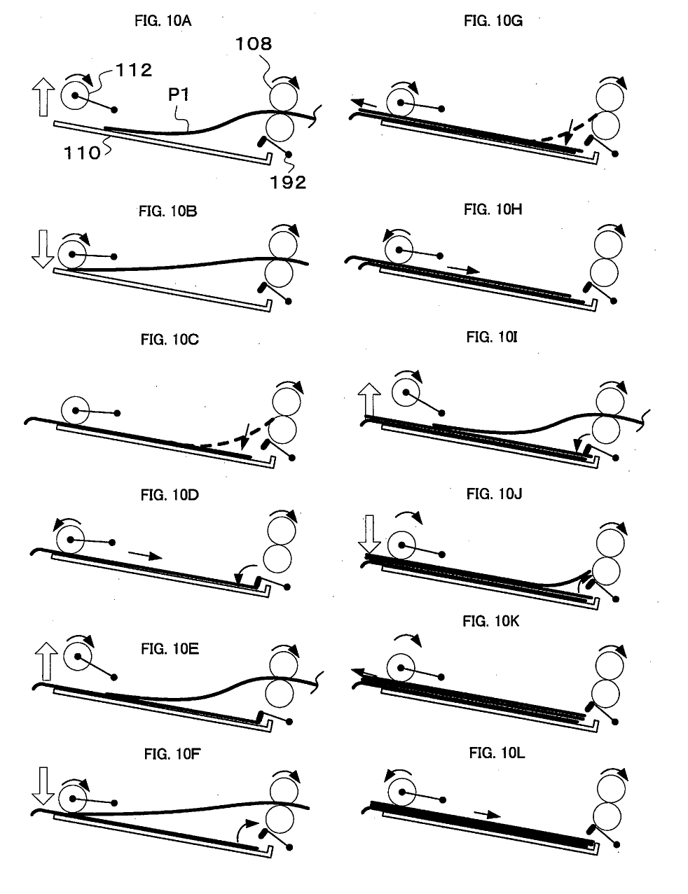

Referring to FIGS. 10A to 10L, a process in which number of sheets L are stacked on the standby tray 110 in a standby state will be described in detail. FIGS. 10A to 10L are diagrams schematically showing a state that sheets stacked on the standby tray 110 become three. In FIGS. 10B to 10L, numerals and symbols applied to similar components in FIG. 10A are omitted.

When a leading end of the first sheet P1 discharged from the exit roller 108 is conveyed to near the standby roller 112, the standby roller 112 moves up and separates from the standby tray 110 (see FIG. 10A). This operation by the standby roller 112 prevents the leading end of the first sheet P1 conveyed to the standby roller 112 from colliding with the standby roller 112. At this moment, the standby roller 112 is rotating in the conveying direction of sheet.

When the first sheet P1 is further conveyed by the exit roller 108, the standby roller 112 approaches the standby tray 110 and then contacts the leading end of the first sheet P1 on the standby tray 110 (see FIG. 10B).

The standby roller 112 further conveys the first sheet P1 on the standby tray 110. Thus, the first sheet P1 is discharged from the exit roller 108 and is loaded on the standby tray 110. Immediately after the first sheet P1 is loaded on the standby tray 110, the controller 210 stops the rotation of the standby roller 112 (see FIG. 10C).

After loading the first sheet P1 on the standby tray 110, the controller 210 makes the standby roller 112 rotate in a reverse direction by several pulses (e.g., 1 to 5 pulses). The sheets P1 moves by the standby roller 112 toward the lower side of the standby tray 110 (upstream side) which is slanted in the conveying direction. The controller 210 makes a chuck 192 turn. The chuck 192 holds the back-end of the sheet (see FIG. 10D). The chuck may have be a constitution that it clutches the end of the sheet or makes the sheet hold on the standby tray 110. The first sheet P1 is supported on the standby tray 110 by the standby roller 112 and the chuck 192 steadily.

When a leading end of a second sheet P2 discharged from the exit roller 108 is conveyed to near the standby roller 112, the standby roller 112 moves up and separates from the first sheet P1 to prevent the leading end of the second sheet P2 from colliding with the standby roller 112 (see FIG. 10E). At this time, the standby roller 112 is rotating in the conveying direction. This operation by the standby roller 112 prevents the second sheet P2 from being jammed even if the second sheet P2 collides with the standby roller 112.

When the second sheet P2 is further conveyed by the exit roller 108, the controller 210 makes the chuck 192 turn to release the holding of the back-end of the first sheet P1. When the second sheet P2 is further conveyed by the exit roller 108, the standby roller 112 approaches the standby tray 110 and contacts the leading end of the second sheet P2 on the standby tray 110 (see FIG. 10F).

The timing at which the standby roller 112 contacts the second sheet P2 may be when the leading end of the first sheet P1 reaches a predetermined position, for example, shifted by 10 mm in the conveying direction toward the upstream side from the leading end of the first sheet P1. The standby roller 112 contacts the second sheet P2 with a state in which the leading ends of sheets P1 and P2 are shifted one the other. The first sheet P1 and the second sheet P2 move to the downstream side in the conveying direction, maintaining the shifted state. Thereafter, the second sheet P2 is discharged from the exit roller 108 and is loaded on the standby tray 110 (see FIG. 10G).

For example, when a predetermined time elapses after the detector 126 detects the leading end or back-end of the sheet, the controller 210 makes the chuck 192 turn or the standby roller 112 move. Alternatively, after the detector 126 detects the leading end or back-end of the sheet, the controller 210 may drive a motor rotating the exit roller 108 by a predetermined number of pulses, and then make the chuck 192 turn or the standby roller 112 move.

After the second sheet P2 is loaded on the standby tray 110, the controller 210 makes the standby roller 112 rotate in a reverse direction by several pulses. The first sheet P1 and the second sheet P2 move by the standby roller 112 toward the lower side of the standby tray 110 which is slanted in the conveying direction (see FIG. 10H).

The controller 210 makes the chuck 192 turn. The chuck 192 holds the back-end of the second sheet P2, as being similar to the first sheet P1. The first sheet P1 and the second sheet P2 are supported on the standby tray 110 by the standby roller 112 and the chuck 192 steadily. When a leading end of a third sheet P3 discharged from the exit roller 108 is conveyed to near the standby roller 112, the standby roller 112 moves up and separates from the second sheet P2 to prevent the leading end of the third sheet P3 from colliding with the standby roller 112. At this point, the standby roller 112 is rotating in the conveying direction (see FIG. 10I).

If the third sheet P3 is further conveyed by the exit roller 108, the controller 210 makes the chuck 192 turn to release holding of the back-end of the second sheet P2. When the third sheet P3 is further conveyed by the exit roller 108, the standby roller 112 approaches the standby tray 110 and touches the leading end of the third sheet P3 on the standby tray 110 (see FIG. 10J). The timing at which the standby roller 112 contacts the third sheet P3 may be when the leading end of the third sheet P3 substantially overlaps with the second sheet P2. The controller 210 makes the chuck 192 turn or the standby roller 112 move on the basis of, for example, either an elapse time from a time that the detector 126 detects the leading end or back-end of the sheet, or number of pulses supplied to a motor.

Maintaining the state in which the leading end of the first sheet P1 is positioned (at downstream side in the conveying direction) ahead of those of the second sheet P2 and the third sheet P3 stacked on the first sheet P1, the controller 210 moves the sheets P1, P2 and P3 to the downstream side in the conveying direction (see FIG. 10K).

The controller 210 drives the motor M2 by a predetermined number of pulses and makes the standby roller 112 rotate reversely. The sheets P1, P2, and P3 move by the standby roller 112 to the lower side of the standby tray 110 which is slanted in the conveying direction (see FIG. 10L).

(Discharging a sheet to a movable tray: sheet discharge control) A process in which a sheet is discharged to the movable tray 122 includes a processing in which a sheet is discharged to the movable tray 122 directly without using the processing tray 114, besides the above-mentioned processing. In a job without stapling or sorting, for example, if one page original is printed to a plurality of copies (or prints) in the image forming apparatus 1, the sheets are discharged to the movable tray 122 one by one by the standby roller 112 without being stopped at and dropped by the standby tray 110 in the post-sheet processing apparatus 100. In this embodiment, without stapling or sorting, the post-sheet processing apparatus 100 switches between a first processing in which it discharges a sheet one by one from the standby tray 110 to the movable tray 122 and a second processing in which it discharges a sheet to the movable tray 122 after the standby tray drops the sheet onto the processing tray 114. Hereinafter, a discharge control for preventing a toner image from sticking is explained in the second processing.

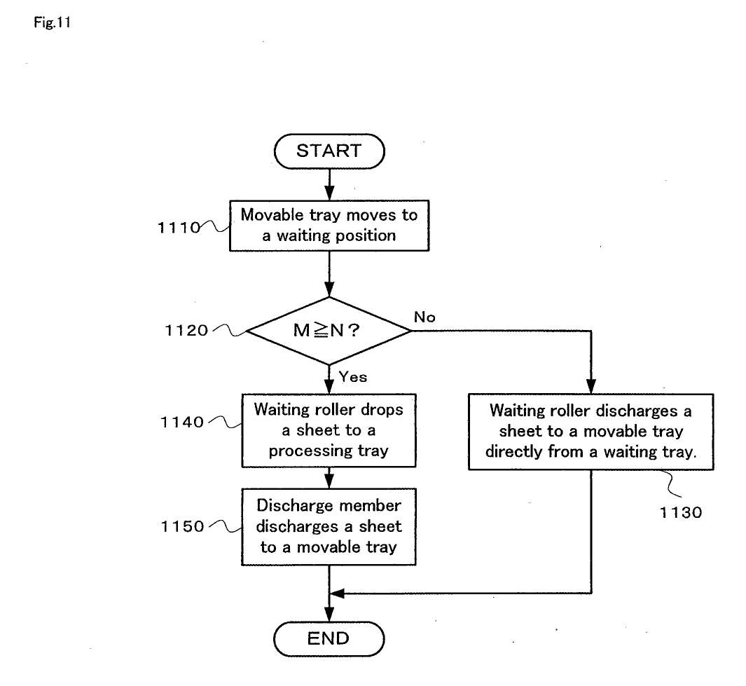

(First embodiment of sheet discharge control) FIG. 11 is a flow chart for explaining an example of discharge control. At 1110, after receiving a job for image-forming instructed from the operation panel 5 or PC220, the movable tray 122 moves to a waiting position at which the detector 124 detects the upper surface of the movable tray 122. The image forming apparatus 1 forms an image on the sheet. The entrance roller 102 conveys the sheet with the image to the post-sheet processing apparatus 100 from the image forming apparatus 1. The entrance roller 102 further conveys the sheet to the branching member 104. The branching member 104 guides the sheet to the exit roller 108. The exit roller 108 discharges the sheet to the standby tray 110 which stands by in the closed state of the first distance.

At 1120, the controller 210 judges whether a value M is bigger than a value N or not. The value M is number of sheets which will be discharged to the movable tray 122. Number of output sheets M is set by a user, e.g., via the operation panel 5 or the PC 220. For example, if the original is one page, the value M may be set as number of copies. The value N is a reference value (threshold value) which is set as a predetermined number of output sheets, and may be set as an initial-setting value by a maker. The initial-setting value may be obtained from a theoretical formula or an experimental result. The initial-setting value may also be set by a user or a particular administrator via the operation panel 5 or the PC 220. The value N may be a comparatively large value, for example, 500, 1000, . . . 3000. A value which is smaller than the value N is defined as a first value, and a value which is larger than the value N is defined as a second value.

If the number of output sheets M is equal to the first value smaller than the value N (No at 1120), the standby roller 112 discharges the sheet to the movable tray 122 directly from the standby tray 110 at 1130. In a word, if the leading end of the sheet discharged from the exit roller 108 and conveyed to the standby tray 110 comes near the standby roller 112, the standby roller 112 moves up from the standby tray 110. When the sheet is further conveyed by the exit roller 108, the standby roller 112 approaches the standby tray 110 and contacts the leading end of the sheet on the standby tray 110. The standby roller 112 conveys and discharges the sheet to the movable tray 122 from the standby tray 110 of the closed state.

If the number of output sheets M is equal to the second value equal to or bigger than the value N (Yes at 1120), the standby tray 110 drops the sheet to the processing tray 114 at 1140. Namely, if the leading end of the sheet discharged from the exit roller 108 and conveyed to the standby tray 110 comes near the standby roller 112, the standby roller 112 moves up from the standby tray 110. After the exit roller 108 further conveys the sheet, the standby roller 112 approaches the standby tray 110 and contacts the leading end of the sheet on the standby tray 110. After completely discharging the sheet on the standby tray 110, the standby roller 112 rotates reversely and conveys the sheet toward the lower side of the standby tray 110. The standby tray 110 moves in the sheet width direction to be the opened state of the second distance and drops the sheet to the processing tray 114.

After the processing tray 114 receives the dropped sheet, the discharge member 120 discharges the sheet to the movable tray 122 at 1150.

In this embodiment, in the processing in which it discharges one sheet at a time to the movable tray 122, the standby tray 110 drops the sheet to the processing tray 114 and then the dropped sheet is discharged to the movable tray 122. Consequently, since the sheet is cooled during falling off the standby tray 110, sheets stacked one the other are not stuck with toner image on the sheet even if a lot of sheets are loaded on the movable tray 122. If an original document has multiple pages, the value M may be decided on the basis of a number of output sheets (a number of copies or a number of prints, hereinafter referred to as number of copies) and a number of pages of the original.

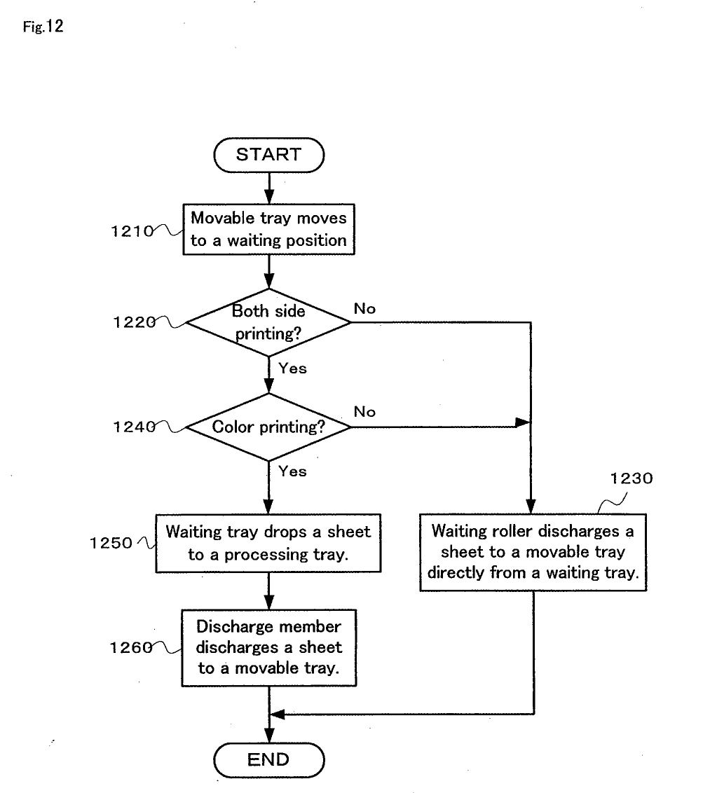

(Second embodiment of sheet discharge control) The toner images of discharged sheets on the movable tray 122, which are fixed in both side printing or color printing, are easy to stick. So another embodiment for discharging the sheet to the movable tray 122 will be explained. FIG. 12 is a flow chart for explaining another example of discharge control of the post-sheet processing apparatus. In this embodiment, the sheet is discharged to the movable tray 122 one by one.

At 1210, after starting a job for image-forming instructed from the operation panel 5 or PC220, the movable tray 122 moves to a waiting position at which the detector 124 detects the upper surface of the movable tray 122. At 1220, the controller 210 judges whether the printing (printing method or conditions) is a both side printing or not.

If a printing is a one-side printing (No at 1220), the standby roller 112 discharges the sheet from the standby tray 110 to the movable tray 122 directly at 1230. If the printing is the both side printing (Yes at 1220), the controller 210 judges whether the printing is a color printing or not at 1240.

If the printing is a black-and-white print or a mono-color printing (No at 1240), the standby roller 112 discharges the sheet from the standby tray 110 to the movable tray 122 directly at 1230. If the printing is the color printing (Yes at 1240), the standby tray 110 drops the sheet to the processing tray 114 at 1250.

After the processing tray 114 receives the dropped sheet, the discharge member 120 discharges the sheet to the movable tray 122 at 1260. The printing conditions are set up by a user via the operation panel 5 or PC220.

In this embodiment, as similar to the above-mentioned embodiment, the sheet is cooled by falling off the standby tray 110 to the processing tray 114, sheets stacked are not stuck one the other with toner image even if a lot of sheets are loaded on the movable tray 122. If an original document has multiple pages, the value M may be decided on the basis of a number of copies and a number of pages of the original. The order of 1220 and 1240 is not limited, namely, may be reversed. The controller 210 may judge the printing at least at either 1220 or 1240. Before or after 1220 or 1240 is executed, the controller 210 may judge whether the value M, number of sheets, is bigger than value N or not, as act 1220 of FIG. 11.

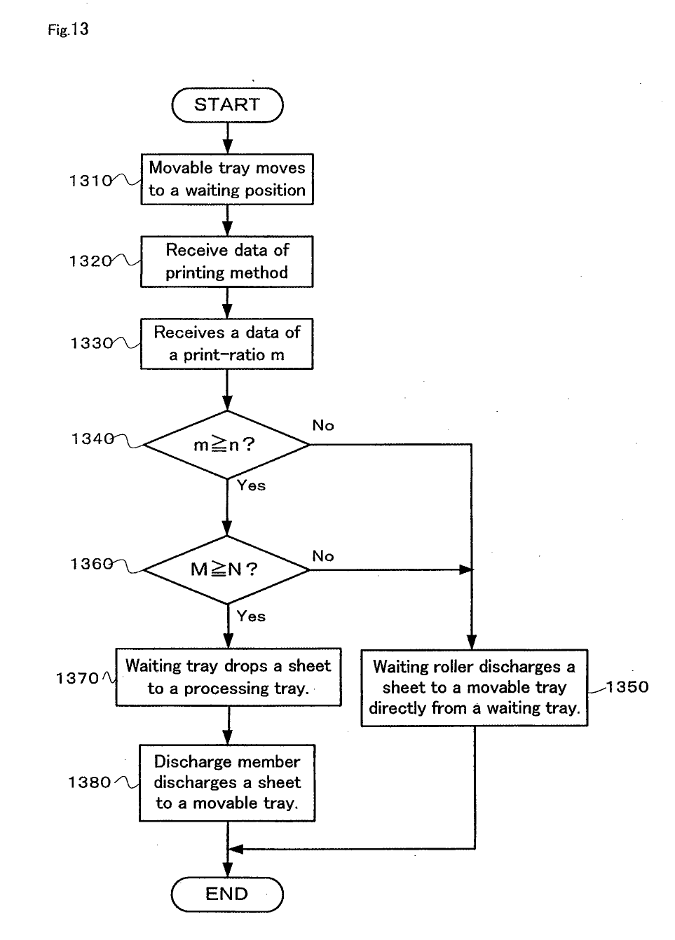

(Third embodiment of discharge control) Furthermore, another embodiment for discharging the sheet to the movable tray 122 will be explained. FIG. 13 is a flow chart for explaining another example of discharge control of the post-sheet processing apparatus. In this embodiment, the sheet is discharged to the movable tray 122 one by one.

At 1310, after starting a job for image-forming instructed from the operation panel 5 or PC220, the movable tray 122 moves to a waiting position at which the detector 124 detects the upper surface of the movable tray 122. At 1320, the controller 210 receives data of printing method (or conditions) from the main controller 200. The printing method includes, for example, one-side/both side printing or black-and-white/color printing, and the like. The controller 210 receives a data of a print-ratio m of original image from the main controller 200 at 1330. The value m is obtained based on, for example, the printing pattern of the original image. The controller 210 judges whether the print-ratio m is bigger than value n or not at 1340. The value n is a reference value (threshold value) set as a predetermined print-ratio. And the value n may be set on the basis of a printing method like one-side/both side printing or black-and-white/color printing, for example, using Lookup table. The value n of both side printing is smaller than that of one-side printing. And the value n of color printing is also smaller than that of black-and-white (or mono-color) printing. The Lookup table in which a relationship between the printing method and the value n is indicated may be stored in a storage device which the controller 220 controls, for example, ROM (Read Only Memory) or HDD (Hard disk drive), and the like. The value n in the Lookup table may be set by a user or a particular administrator via the operation panel 5 or the PC 220. The value n may be fixed before shipping. A value smaller than the value n is defined as a third value, and a value larger than the third value is defined as a fourth value.

If the value m is equal to the third value smaller than the value n (No at 1340), the standby roller 112 discharges the sheets from the standby tray 110 to the movable tray 122 directly at 1350. If the value m is equal to either the value n or the fourth value bigger than the value n (Yes at 1340), the controller 210 judges whether the number of output sheets M is bigger than the value N or not (At 1360).

If the number of output sheets M is smaller than the value N (No at 1360), the standby roller 112 discharges the sheets from the standby tray 110 to the movable tray 122 directly at 1350. If the number of output sheets M is bigger than the value N (Yes at 1360), the standby tray 110 drops the sheets to the processing tray 114 at 1370.

After the processing tray 114 receives the dropped sheets, the discharge member 120 discharges the sheets to the movable tray 122 at 1380.

In this embodiment, as similar to the above-mentioned embodiments, sheet is cooled sufficiently by falling off the standby tray 110 to the processing tray 114, so toner images fixed on the sheets don't stick between the sheets. The controller 210 changes from a sheet path at which the sheet is discharged directly to another sheet path at which the sheet is conveyed through the processing tray 114 on the basis of not only a number of copies but also the print-ratio, so a depression of throughput of the post-sheet processing apparatus is reduced properly. The order of 1340 and 1360 may be reversed. The controller 210 may not carry out judgment at 1360.

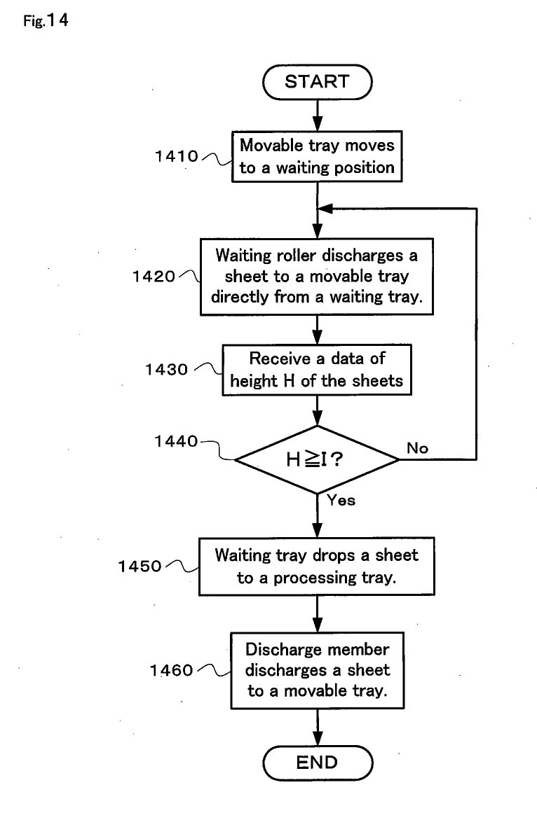

(Fourth embodiment of sheet discharge control) Furthermore, another embodiment for discharging the sheet to the movable tray 122 will be explained. FIG. 14 is a flow chart for explaining another example of discharge operation of the post-sheet processing apparatus. In this embodiment, the operation of discharging changes from discharging the sheet directly from the standby tray 110 to discharging the sheet after conveying through the processing tray 114 during the job. In this embodiment also, sheet is discharged to the movable tray 122 one by one.

At 1410, after starting a job for image-forming instructed from the operation panel 5 or PC220, the movable tray 122 moves to a position at which the detector 124 detects the upper surface of the movable tray 122. After the exit roller 108 conveys the sheet onto the standby tray 110, the standby roller 112 discharges the sheet from the standby tray 110 to the movable tray 122 directly at 1420. The controller 210 receives a data of height H of the sheets stacked on the movable tray 122 at 1430. In this embodiment, the movable tray 122 receives the sheet at a position at which the detector 124 detects the upper surface of the movable tray 122 or the sheets on the movable tray 122. So the controller 210 receives the sheet height H on the basis of the respective positions at which the plurality of detectors 125 detect the movable tray 122. A sensor detecting the sheet height may be utilized, separately. Alternatively, the sheet height H may be calculated based on a number of output sheets.

At 1440, the controller 210 judges whether the height H is bigger than a value I or not. The value I is a reference value (threshold value) which is set as a predetermined height, and may be set as an initial-setting value by a maker. The initial-setting value may be obtained from a theoretical formula or an experimental result. The initial-setting value also may be set by a user or a particular administrator via the operation panel 5 or the PC 220. As similar to the above-mentioned value N, a value smaller than the value I is defined as a first value, and a value larger than the value I is defined as a second value.

If the sheet height H is equal to the first value smaller than the value I (No at 1440), the standby roller 112 discharges the sheets to the movable tray 122 directly from the standby tray 110 at 1420. If the sheet height H is equal to the second value bigger than the value I (Yes at 1440), the standby tray 110 drops the sheets to the processing tray 114 at 1450. After the processing tray 114 receives the dropped sheets, the discharge member 120 discharges the sheets to the movable tray 122 at 1460.

In this embodiment, as similar to the above-mentioned embodiments, the sheet is cooled sufficiently by falling off the standby tray 110 to the processing tray 114, so toner images fixed on the sheets are prevented from sticking between the sheets on the movable tray 122. The controller 210 changes from a sheet path at which the sheet is discharged directly to another sheet path at which the sheet is conveyed through the processing tray 114 on the basis of the sheet height H, so an extreme depression of throughput can be reduced. The operation of 1430 and 1440 may be performed with respect to each job.

A number of output sheet M′ and the value N may be used instead of the loaded sheet height H and the value I. For example, at 1430, the detector 126 detects the conveyed sheet, and the controller 210 counts the number of output sheets M′. At 1440, the controller 210 judges whether the value M′ is bigger than the value N or not.

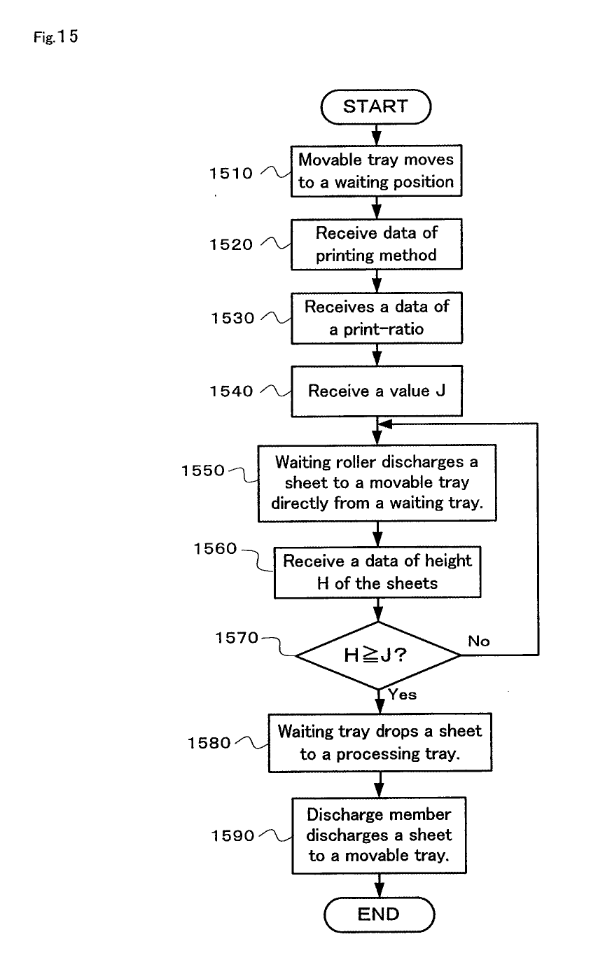

(Fifth embodiment of sheet discharge control) Furthermore, another embodiment of discharging the sheet to the movable tray 122 will be explained. FIG. 15 is a flow chart for explaining another example of discharge control of the post-sheet processing apparatus. In this embodiment also, the sheet is discharged to the movable tray 122 one by one.

At 1510, after starting a job for image-forming instructed from the operation panel 5 or PC220, the movable tray 122 moves to a position at which the detector 124 detects the upper surface of the movable tray 122. At 1520, the controller 210 receives data of printing method (or conditions) from the main controller 200. The printing method includes, for example, one-side/both side printing or black-and-white/color printing, and the like. At 1530, the controller 210 receives the print-ratio m of original image from the main controller 200. At 1540, the controller 210 receives a value J. The value J is a reference value (threshold value) which is set as a predetermined height and is determined on the basis of, for example, the printing method like one-side/both side printing and/or black-and-white/color printing and print-ratio m.

Method of determination of value J will be explained. The value k is a coefficient of print-ratio.

J=k×L Formula 1

k=(100−(m/5))/100 Formula 2

The value L is determined, for example, based on the printing method such as, one-side/both side printing and/or black-and-white/color printing, using a table 1. The value L may be set as an initial-setting value by a maker. The value L may also be set by a user or a particular administrator via the operation panel 5 or the PC 220.

TABLE 1

| | one-side | both side |
|---|---|---|
| L: (mm) | printing | printing |
| black and white printing | 120 | 100 |
| color printing | 120 | 60 |

After the exit roller 108 conveys the sheet onto the standby tray 110, the standby roller 112 discharges the sheet from the standby tray 110 to the movable tray 122 directly at 1550. The controller 210 receives a height data H of the sheets loaded on the movable tray 122 at 1560. At 1570, the controller 210 judges whether the height H is greater than a value J or not. As similar to the above-mentioned values N and I, a value smaller than the value J is defined as a first value, and a value larger than the value J is defined as a second value.

If the stacked sheet height H is equal to the first value smaller than the value J (No at 1570), the standby roller 112 discharges the sheets to the movable tray 122 directly from the standby tray 110 at 1550. If the sheet height H is equal to either the value J or the second value bigger than the value J (Yes at 1570), the standby tray 110 drops the sheet to the processing tray 114 at 1580. After the processing tray 114 receives the dropped sheet, the discharge member 120 discharges the sheet to the movable tray 122 at 1590.

In this embodiment, the same effect as that of the above-mentioned embodiments can be achieved. The controller 210 properly determines a prescribed height J on the basis of the printing method and print-ratio m. Consequently, a depression of throughput can be reduced more properly by changing the sheet path during the operation on the basis of the stacked sheet height H and value J.

The value J may be determined without using the print-ratio m or the coefficient of print-ratio. Namely, The value J may be equal to the value L based on the printing method such as one-side/both side printing and/or black-and-white/color printing.

A number of output sheets M′ and the value N may be used instead of the stacked sheet height H and the value J. For example, the value N is determined in the Look-up table form based on the printing method, e.g., one-side/both side printing, black-and-white/color printing, and the like, or the print-ratio m.

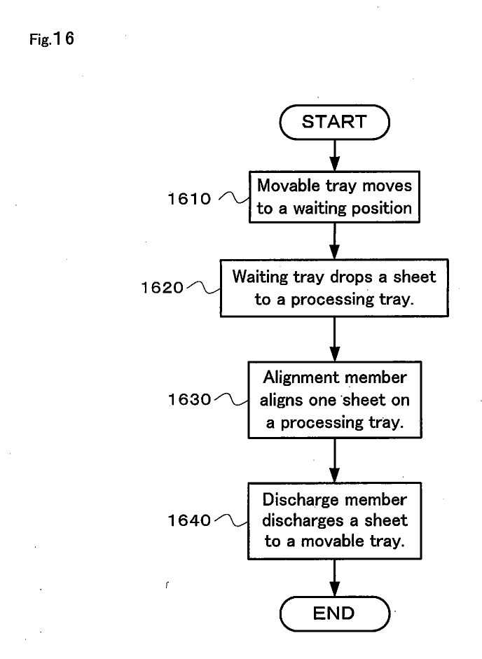

(Sixth embodiment of sheet discharge control) Furthermore, another embodiment for discharging the sheet to the movable tray 122 will be explained. FIG. 16 is a flow chart for explaining another example of discharge control. In this embodiment, the sheet is discharged to the movable tray 122 one by one.

At 1610, when image-forming begins by the instruction from the operation panel 5 or PC220, the movable tray 122 moves to a position at which the detector 124 detects the upper surface of the movable tray 122. The controller 210, as shown in the above-mentioned embodiments of sheet discharge control (first to fifth) in the FIG. 11 to FIG. 15, determines an operation whether the standby tray 110 drops the sheet to the processing tray 114 or not, on the basis of the threshold value (for example, 1120 in FIGS. 11, 1220 and 1240 in FIG. 12). At 1620, the standby tray 110 drops the sheet to the processing tray 114. After the processing tray 114 receives the dropped sheet, the alignment member 116 aligns the sheet on the processing tray 114 in a width direction crossing a sheet conveying direction at 1630. At 1640, the discharge member 120 discharges the aligned sheet to the movable tray 122.

In this embodiment, the same effect as that in the above-mentioned embodiments is obtained. Furthermore, when the sheet is conveyed through the processing tray 114, the alignment member 116 aligns the sheet. So a skew of the sheet in a sheet conveying direction can be prevented. Consequently, a stability of the sheets stacked on the movable tray 122 is improved. A lot of sheets stacked on the movable tray 122 can be prevented from being unpiled.

The control of this embodiment is effective to an apparatus in which the problem of sticking toner image is not observed or rarely observed.

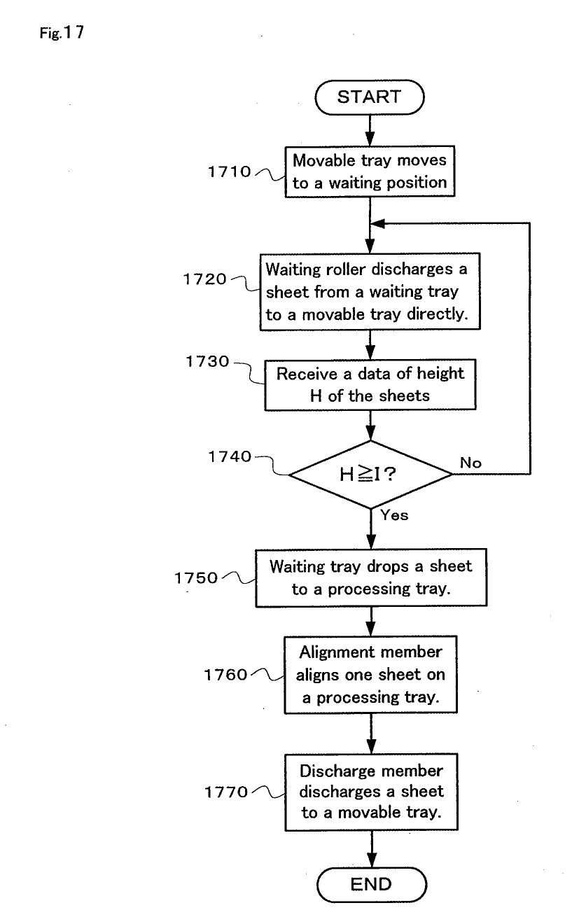

For example, as shown in FIG. 17, when image-forming begins by instruction from the operation panel 5 or PC220, the movable tray 122 moves to a position at which the detector 124 detects the upper surface of the movable tray 122 at 1710. At 1720, the standby roller 112 discharges the sheet from the standby tray 110 to the movable tray 122 directly. The controller 210 receives height data H of the sheets stacked on the movable tray 122 at 1730. At 1740, the controller 210 judges whether the height H is greater than a value I or not. If the sheet height H is smaller than value I (No at 1740), the standby roller 112 discharges the sheet to the movable tray 122 directly from the standby tray 110 at 1720. If the sheet height H is equal to or greater than the value I (Yes at 1740), the standby tray 110 drops the sheet to the processing tray 114 at 1750. After the processing tray 114 receives the dropped sheet, the alignment member 116 aligns one sheet on the processing tray 114 in a width direction crossing a sheet conveying direction at 1760. At 1770, the discharge member 120 discharges the aligned sheet to the movable tray 122.

Namely, by discharging the sheet after aligning it in the width direction of sheet, a lot of sheets stacked on the movable tray 122 can be prevented from being unpiled.

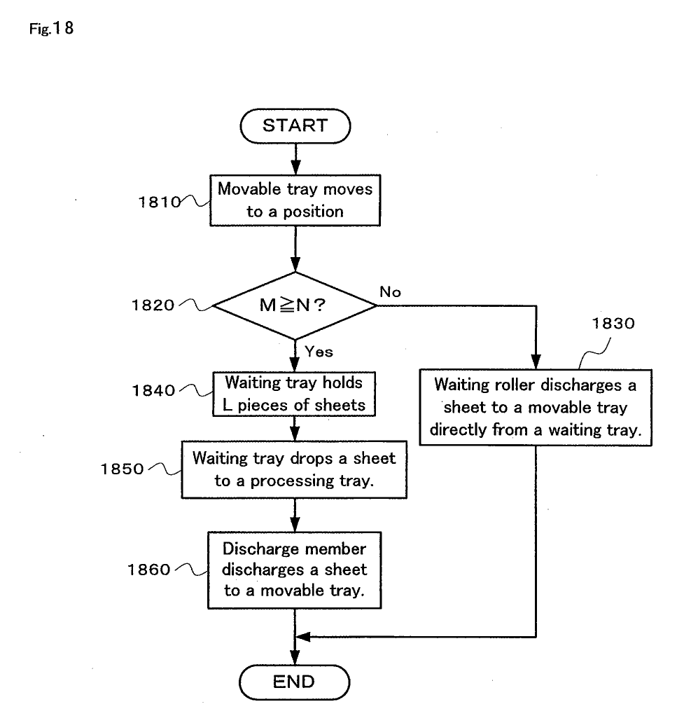

(Seventh embodiment of sheet discharge control) Furthermore, another embodiment for discharging the sheet to the movable tray 122 will be explained. In the above mentioned first to sixth embodiments, examples of sheet discharge control for discharging the sheet one by one are explained. In this embodiment, however, example of sheet discharge control for discharging by several sheets at a time will be explained. FIG. 18 is a flow chart for explaining an example of sheet discharge control.

At 1810, when image-forming begins by the instruction from the operation panel 5 or PC220, the movable tray 122 moves to a position at which the detector 124 detects the upper surface of the movable tray 122. The image forming apparatus forms an image on a sheet. The entrance roller 102 conveys the sheet with the image to the post-sheet processing apparatus 100 from the image forming apparatus 1. The entrance roller 102 further conveys the sheet to the branching member 104. The branching member 104 guides the sheet to the exit roller 108. The exit roller 108 discharges the sheet to the standby tray 110 which stands by in the closed state of the first distance.

At 1820, the controller 210 judges whether a value M is greater than a value N or not. The value M is number of sheets to be output to the movable tray 122 after printing. Number of output sheets M is set by a user, via the operation panel 5 or the PC 220. For example, if the original is one page, the value M may be set as number of copies. The value N is a reference value (threshold value) which is set as a predetermined number of output sheets. The value N may be set as an initial-setting value by a maker. The initial-setting value may be obtained from a theoretical formula or an experimental result. The initial-setting value also may be set by a user or a particular administrator via the operation panel 5 or the PC 220. The value N may be a comparatively large value, for example, 500, 1000, . . . 3000. A value smaller than the value N is defined as a first value, and a value larger than the value N is defined as a second value.

If the number of output sheets M is equal to the first value smaller than the value N (No at 1820), the standby roller 112 discharges the sheet to the movable tray 122 directly from the standby tray 110 at 1830. In a word, if the leading end of the sheet which is discharged from the exit roller 108 and is conveyed on the standby tray 110 comes near the standby roller 112, the standby roller 112 moves up from the standby tray 110. When the sheet is further conveyed by the exit roller 108, the standby roller 112 approaches the standby tray 110 and contacts to the leading end of the sheet on the standby tray 110. The standby roller 112 conveys and discharges the sheet to the movable tray 122 from the standby tray 110 which is in the closed state of the first distance.

If the number of output sheets M is equal to the second value equal to or greater than the value N (Yes at 1820), the standby tray 110 holds number of sheets L at 1840. After holding number of sheets L, the standby tray 110 drops number of sheets L held to the processing tray 114 at 1850. In succeeding sheets also, the standby tray 110 drops the sheets to the processing tray 114 every time that number of sheets L are stacked.

After the processing tray 114 receives the dropped sheet, the discharge member 120 discharges the aligned sheet to the movable tray 122 at 1850. The discharge member 120 may discharge the sheets every time that number of sheets L are stacked on the processing tray 114. Or the discharge member 120 may discharge the sheets at a time after the processing tray 114 receives all output sheets of one copy job.

In this embodiment, since a process in which a sheet is normally discharged on the movable tray 122 one by one is changed to a process in which several sheets are discharged at a time in case that sheets are dropped on the processing tray 114 based on a threshold value, the same effect as that in the above-mentioned embodiments is achieved.

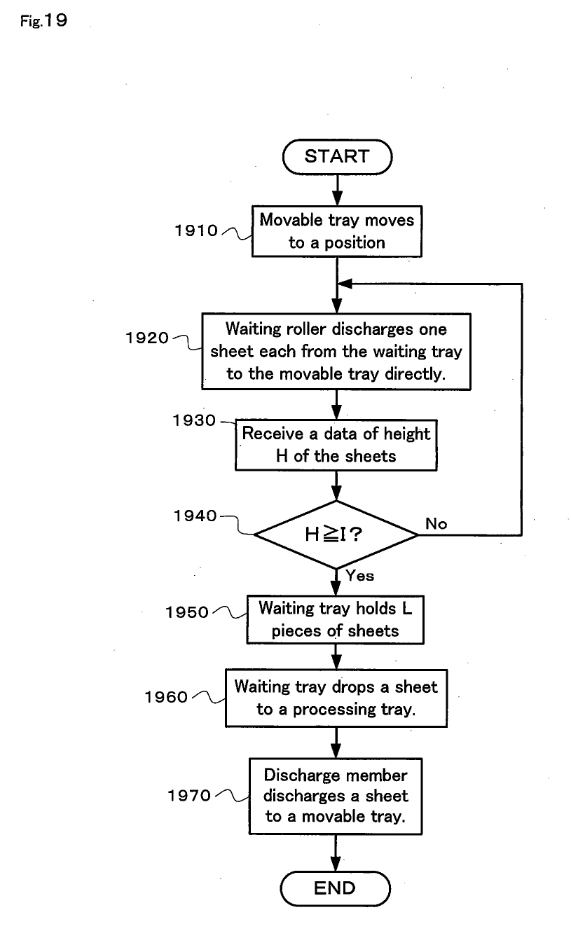

(Eighth embodiment of sheet discharge control) Furthermore, still another embodiment for discharging sheet to the movable tray 122 will be explained. FIG. 19 is a flow chart for explaining an example of sheet discharge control. In this embodiment, the operation of sheet discharging is changed from discharging the sheet directly from the standby tray 110 to discharging the sheet after conveying it through the processing tray 114 during the job.

At 1910, when image-forming begins by the instruction from the operation panel 5 or PC220, the movable tray 122 moves to a position at which the detector 124 detects the upper surface of the movable tray 122. After the exit roller 108 conveys the sheet onto the standby tray 110, the standby roller 112 discharges the sheet one by one from the standby tray 110 to the movable tray 122 directly at 1920. The controller 210 receives a data of height H of the sheets stacked on the movable tray 122 at 1930. In this embodiment, the movable tray 122 receives the sheet at a position at which the detector 124 detects the upper surface of the movable tray 122 or the sheets on the movable tray 122. So the controller 210 receives data of the sheet height H on the basis of the position of the movable tray 122 that the plurality of detectors 125 detect. Another sensor which detects the sheet height may be used. Alternatively, the sheet height H stacked may be calculated based on a number of output sheets.

At 1940, the controller 210 judges whether the height H is greater than a value I or not. The value I is a reference value (threshold value) which is set as a predetermined height, and may be set as an initial-setting value by a maker. The initial-setting value may be obtained from a theoretical formula or an experimental result. The initial-setting value may be set also by a user or a particular administrator via the operation panel 5 or the PC 220. As similar to the above-mentioned value N, a value smaller than the value I is defined as a first value, and a value larger than the value I is defined as a second value.

If the sheet height H is equal to the first value smaller than the value I (No at 1940), the standby roller 112 discharges the sheet one by one from the standby tray 110 to the movable tray 122 directly at 1420. If the sheet height H is equal to either the value I or the second value greater than the value I (Yes at 1940), the standby tray 110 holds number of sheets L at 1950. After holding number of sheets L, the standby tray 110 drops at a time the number of sheets L held to the processing tray 114 at 1960. The standby tray 110 drops the sheets to the processing tray 114 every time that successive number of sheets L are stacked thereon.

After the processing tray 114 receives the dropped sheet, the discharge member 120 discharges the aligned sheet to the movable tray 122 at 1970. The discharge member 120 may discharge the sheets every time that number of sheets L are stacked thereon. Or the discharge member 120 may discharge the sheets at a time after the processing tray 114 receives all output sheets in one copy job.

The sheet discharge control in which it discharges several sheets at a time is not limited to the above-mentioned embodiments (Seventh and eighth embodiments). It may be applied to the above described first to sixth embodiments, respectively.

For example, in a first period, the standby tray 110 drops several sheets at a time to the processing tray 114, and in a successive second period, the standby tray 110 may drop the sheet one by one to the processing tray 114. Number of sheets which the standby tray 110 holds may be changed with regard to respective stages. For example, in a first period, the standby tray 110 drops the sheet one by one to the movable tray 122 directly, in a successive second period, the standby tray 110 drops several sheets at a time to the processing tray 114, and in the last period, the standby tray 110 drops the sheet one by one to the processing tray 114.

In above-mentioned embodiment, the image forming apparatus 1 of an electro-photographic printing process to which the post-sheet processing apparatus 100 is connected has the fixing device 38. However, the image forming apparatus 1 does not necessarily need to be equipped with the fixing device 38. For example, the image forming apparatus 1 may have an image forming section 2 of an ink-jet printing process as a printer. In an ink-jet printing process, if a sheet on which ink image is formed is stacked before ink image on the sheet is fully dried, it is apt to stick sheets stacked one another with ink when ink is dried. In addition, if sheets of large quantity are stacked, since ink images on the respective sheets are pressed by the stacked sheets, sticking of ink image between the stacked sheets becomes large. In particular, if the processing speed (PPM) of the image forming apparatus 1 and the post-sheet processing apparatus 100 is increased, possibility of sticking of ink image to a stacked sheet becomes large. However, according to the sheet discharge control of the present invention, a sheet on which ink image is formed is fully dried by dropping it in the air. Therefore, it can restrain ink image on the sheet from sticking stacked sheets one another.

The present invention is not limited to the above-mentioned embodiments. It is possible to modify and embody the elements without departing from the spirit of the invention. It is possible to form various inventions by appropriately combining the plural elements disclosed in the embodiments. For example, several elements may be deleted from all the elements disclosed in the embodiments. The elements disclosed in the different embodiments may be appropriately combined.

What is claimed is:

1. A sheet processing apparatus, comprising:
a first supporting member configured to support a sheet and drop the sheet;
a second supporting member configured to support the sheet dropped by the first supporting member;
a stacking member configured to stack sheets;
a first discharge member configured to discharge the sheet from the first supporting member to the stacking member;
a second discharge member configured to discharge the sheet on the second supporting member to the stacking member; and
a control unit configured to control the first discharge member to discharge the sheet one by one from the first supporting member to the stacking member if a volume of sheets which are discharged to the stacking member is a first value smaller than a threshold value and to control the first supporting member to drop the sheet to the second supporting member if the volume of sheets which are discharged to the stacking member is a second value greater than the threshold value.

2. The sheet processing apparatus according to claim 1, further comprising a detector configured to detect the volume of sheets,
wherein the control unit is configured to control the first supporting member to drop the sheet to the second supporting member if the volume of sheets detected by the detector becomes the second value from the first value.

3. The sheet processing apparatus according to claim 1, wherein the volume of sheets is a number of sheets which is discharged to the stacking member.

4. The sheet processing apparatus according to claim 2, wherein the volume of sheets is a height of stacked sheets on the stacking member.

5. The sheet processing apparatus according to claim 1, wherein the threshold value is determined based on a printing method received from an external apparatus.

6. The sheet processing apparatus according to claim 1, wherein the threshold value is determined based on a printing rate received from the external apparatus.

7. The sheet processing apparatus according to claim 1, wherein the control unit is configured to control the first discharge member to discharge the sheet one by one to the stacking member if a printing rate received from an external apparatus is a third value smaller than a predetermined threshold value of printing rate and to check whether the volume of sheets is either the first value or the second value if the printing rate is a fourth value greater than the threshold value of the printing rate.

8. The sheet processing apparatus according to claim 1, wherein the second discharge member is configured to discharge the sheet on the second supporting member to the stacking member upon receipt of the sheet by the second supporting member.

9. The sheet processing apparatus according to claim 1, wherein the first supporting member is configured to support the sheet in a first spacing state and drop the sheet in a second spacing state broader than the first spacing state in a direction crossing a sheet conveying direction.

10. The sheet processing apparatus according to claim 1, further comprising an alignment member configured to move back and forth between a first position and a second position in a direction crossing a sheet conveying direction and to align the sheet supported on the second supporting member at the second position.

11. The sheet processing apparatus according to claim 10, wherein the alignment member is configured to move back and forth between the first position and the second position whenever the sheet is supported on the second supporting member.

12. The sheet processing apparatus according to claim 1, wherein the control unit is configured to control the first supporting member to drop the sheet one by one to the second supporting member.

13. The sheet processing apparatus according to claim 1, further comprising a stapler configured to staple sheets on the second supporting member after receiving an instruction of stapling.

14. An image forming apparatus, comprising:
a printer configured to form an image on a sheet;
a first supporting member configured to support the sheet and drop the sheet;
a second supporting member configured to support the sheet dropped by the first supporting member;
a stacking member configured to stack sheets;
a first discharge member configured to discharge sheet from the first supporting member to the stacking member;
a second discharge member configured to discharge the sheet on the second supporting member to the stacking member; and
a control unit configured to control the first discharge member to discharge the sheet one by one from the first supporting member to the stacking member if a volume of sheets discharged to the stacking member is a first value smaller than a threshold value and to control the first supporting member to drop the sheet to the second supporting member if the volume of sheets discharged to the stacking member is a second value greater than the threshold value.

15. A sheet processing method for discharging a sheet to a stacking member, comprising:
supporting a conveyed sheet by a first supporting member;
discharging the sheet from the first supporting member to the stacking member if a volume of sheets discharged to the stacking member is a first value smaller than a threshold value;
dropping the sheet supported on the first supporting member to a second supporting member if the volume of sheets discharged to the stacking member is a second value greater than the threshold value; and
discharging the sheet on the second supporting member to the stacking member.

16. The method according to claim 15, further comprising detecting the volume of sheets by a detector; and
dropping the sheet to the second supporting member by the first supporting member after detecting that the volume of sheets becomes the second value from the first value.

17. The method according to claim 15, further comprising;
discharging the sheet one by one by the first discharge member from the first supporting member to the stacking member if a printing rate received from an external apparatus is either a third value smaller than a predetermined threshold value of printing rate or a forth value greater than the threshold value of the printing rate and, the volume of sheets is the first value;
dropping the sheet supported on the first supporting member to a second supporting member if the printing rate is the forth value and the volume of sheets is the second value; and
discharging to the stacking member the sheet on the second supporting member dropped from the first supporting member.

18. The method according to claim 15, further comprising; aligning the sheet supported on the second supporting member by an alignment member which moves back and forth between a first position and a second position in a direction crossing a sheet conveying direction and contacts the sheet at the second position.

19. The method according to claim 15, wherein the volume of sheets is a number of sheets discharged to the stacking member.

20. The method according to claim 16, wherein the volume of sheets is a height of stacked sheets on the stacking member.
